(19) United States
(12) Patent Application Publication
(10) Pub. No.: US 2023/0178721 A1
(43) Pub. Date: Jun. 8, 2023

(54) NEGATIVE ELECTRODE FOR LITHIUM SECONDARY BATTERY AND LITHIUM SECONDARY BATTERY COMPRISING SAME

(71) Applicant: SAMSUNG SDI CO., LTD., Yongin-si, Gyeonggi-do (KR)

(72) Inventors: Hyeseung JUNG, Yongin-si (KR); Jaeho LEE, Yongin-si (KR); Soochan KIM, Yongin-si (KR); Chaewoong CHO, Yongin-si (KR)

(21) Appl. No.: 17/997,354

(22) PCT Filed: Apr. 27, 2021
(86) PCT No.: PCT/KR2021/005289

§ 371 Date: Oct. 27, 2022

(30) Foreign Application Priority Data
May 6, 2020 (KR) 10-2020-0053963

(51) Int. Cl. H01M 4/485; H01M 4/583; H01M 4/38; H01M 10/0525; H01M 4/62

(52) U.S. Cl. CPC H01M 4/485; H01M 4/583; H01M 4/386; H01M 10/0525; H01M 4/625; H01M 2004/027

(57) ABSTRACT

The present invention relates to a negative electrode for a lithium secondary battery and a lithium secondary battery comprising same. The negative electrode for a lithium secondary battery comprise: a current collector; and a negative electrode active material layer formed on the current collector and comprising a, negative electrode active material, lithium titanium oxide, and a conductive material, wherein 2 wt % or less of lithium titanium oxide is contained relative to 100 wt % of the negative electrode active material layer.

### CROSS-REFERENCE TO RELATED APPLICATIONS

This application is a U.S. National Phase Patent Application of International Application Number PCT/KR2021/005289, filed on Apr. 27, 2021, which claims priority of Korean Patent Application Number 10-2020-0053963, filed on May 6, 2020, the entire content of each of which is incorporated herein by reference.

### TECHNICAL FIELD

This relates to a negative electrode for a lithium secondary battery and a lithium secondary battery including the same.

### BACKGROUND ART

Recently, for small portable electronic devices, a lithium secondary battery uses an organic electrolyte solution and thereby has twice or more as high a discharge voltage as a conventional battery using an alkali aqueous solution, and accordingly, has high energy density.

As for a positive electrode active material of a rechargeable lithium battery, oxides including lithium and a transition metal with a structure capable of intercalating/deintercalating lithium ions, such as LiCoO₂, LiMn₂O₄, LiNi₁₋ₓCoₓO₂ (0<x<1), and the like has been mainly used.

As for negative electrode active materials, various carbon-based materials capable of intercalating/deintercalating lithium ions such as artificial graphite, natural graphite, hard carbon, and the like, a silicon-based negative electrode active material, or a combination thereof may be mainly used.

### Technical Problem

One embodiment provides a negative electrode for a lithium secondary battery exhibiting excellent cycle-life characteristic, high-capacity and excellent electrical conductivity.

Another embodiment provides a lithium secondary battery including the negative electrode.

### Technical Solution

One embodiment provides a negative electrode for a lithium secondary battery including a current collector and a negative electrode active material layer formed on the current collector and including a negative electrode active material, lithium titanium oxide, and a conductive material, wherein an amount of the lithium titanium oxide is 2 wt % or less relative to 100 wt % of the negative electrode active material layer.

The conductive material may be a particle-shaped carbon, a fiber-shaped carbon, or a combination thereof. The conductive material may be denka black, carbon black, carbon nanotubes, carbon fiber, carbon nanowire, or a combination thereof.

The particle-shaped carbon may have a particle diameter of 5 nm to 700 nm. Furthermore, the fiber-shaped carbon has a length of 5 μm to 200 μm and a diameter of 20 nm or less.

The amount of lithium titanium oxide may be 0.001 wt % to 2 wt % relative to 100 wt % of the negative electrode active material layer.

A total amount of lithium titanium oxide and the conductive material may be 3.5 wt % or less relative to 100 wt % of the negative electrode active material layer.

A mixing ratio of the lithium titanium oxide and the conductive material is 0.002:1 to 4:1 by weight ratio.

Lithium titanium oxide may be represented by Chemical Formula 1.

Li₄₊ₓTi_{y}M_{z}Oₜ [Chemical Formula 1]

(in Chemical Formula 1, 0<x≤3, 1≤y≤5, 0≤z≤3, 3≤t≤12, and M is an element selected from Mg, La, Tb, Gd, Ce, Pr, Nd, Sm, Ba, Sr, Ca, or a combination thereof)

The negative electrode active material is a carbon-based active material, a silicon-based active material, or a combination thereof.

Another embodiment provides a lithium secondary battery including the negative electrode, a positive electrode, and an electrolyte.

Other embodiments of the present invention are included in the following detailed description.

### Advantageous Effects

A negative electrode for a lithium secondary battery according to one embodiment may exhibit excellent cycle-life characteristics, high capacity, and high electrical conductivity.

### BRIEF DESCRIPTION OF THE DRAWING

FIG. 1 is a schematic diagram showing a structure of a lithium secondary battery according to an embodiment.

### MODE FOR INVENTION

Hereinafter, embodiments of the present invention are described in detail. However, these embodiments are examples, the present invention is not limited thereto and the present invention is defined by the scope of the claims.

A negative electrode for a lithium secondary battery according to one embodiment includes a current collector and a negative electrode active material layer formed on the current collector and including a negative electrode active material, lithium titanium oxide, and a conductive material. Herein, an amount of lithium titanium oxide may be 2 wt % or less, relative to 100 wt % of the negative electrode active material layer, and according to one embodiment, may be 0.001 wt % to 2 wt %, or according to another embodiment, 0.5 wt % to 2 wt %.

As such, the negative electrode for the lithium secondary battery according to one embodiment includes lithium titanium oxide and the conductive material in the negative electrode active material layer, and specifically, a small amount of 2 wt % or less of lithium titanium oxide.

Lithium titanium oxide is a material having physical properties such as high rate capability characteristics, a volumetric expansion rate of close to zero, high ionic conductivity, and a high operation voltage (about 1.5 V), and when it is used together with the negative electrode active material in the negative electrode active material layer at 2 wt % or less relative to 100 wt % of the negative electrode active material layer, the merits of lithium titanium oxide may be imparted to the negative electrode, thereby improving the cycle-life characteristics.

Furthermore, the negative electrode active material layer according to one embodiment further includes a conductive material in order to compensate low electrical conductivity of lithium titanium oxide. When the negative electrode active material layer further includes the conductive material, the cycle-life characteristics by using lithium titanium oxide may be further improved.

That is, when the negative electrode active material layer further includes lithium titanium oxide and the conductive material, the cycle-life characteristics owing to the use of lithium titanium oxide may be improved, and particularly, a low temperature cycle-life characteristic, high-rate charge cycle-life characteristics, and high-rate discharge cycle-life characteristics may be improved.

A total amount of lithium titanium oxide and the conductive material may be, relative to 100 wt % of the negative electrode active material layer, 3.5 wt % or less, and according to one embodiment, 0.1 wt % to 3.5 wt %, according to one embodiment, 0.1 wt % to 3 wt %, or according to another embodiment, 1 wt % to 3 wt %. When the total amount of lithium titanium oxide and the conductive material is 3.5 wt % or less, while the reduction of the specific capacity due to the low capacity of lithium titanium oxide and decreases in the operation voltage of the lithium secondary battery due to a high operation voltage of lithium titanium oxide may be minimized and the effects from using lithium titanium oxide and the conductive material ay be sufficiently obtained.

A mixing ratio of lithium titanium oxide and the conductive material may be 0.002:1 to 4:1 by weight ratio, according to one embodiment, 0.002:1 to 11 by weight ratio, or according to one embodiment, 2:1 to 1:1 by weight ratio. The mixing ratio of lithium titanium oxide and the conductive material within the range may compensate the low conductivity of lithium titanium oxide and may increase a BET by using the conductive material, and particularly, the conductive material with a small particle diameter, causing to require no increases in the amount of the binder, thereby increasing a fraction of the active material.

Lithium titanium oxide may be represented by Chemical Formula 1.

Li₄₊ₓTi_{y}M_{z}Oₜ [Chemical Formula 1]

In Chemical Formula 1, 0<x≤3, 1≤y≤5, 0≤z≤3, 3≤t≤12, and M is an element selected from Mg, La, Tb, Gd, Ce, Pr, Nd, Sm, Ba, Sr, Ca, or a combination thereof. For example, the lithium titanium oxide may be Li₄₊ₓTi₅O₁₂.

Lithium titanium oxide may have unspecified shapes, that is, any shapes, and may be used with a size of 100 nm to 5 μm, regardless of shapes. The size, for example, refers to a particle diameter, if lithium titanium oxide is a particle-shaped; refers to a length of the long axis, if it is linear-shaped; or refers to a length of the long axis, if it is an unspecified shape. The lithium titanium oxide having the size within the range may render to uniformly distribute it in the negative electrode active material layer, and thus, lithium titanium oxide may be uniformly and totally distributed in the active material layer.

The conductive material may be a particle-shaped carbon, a fiber-shaped carbon, or a combination thereof, and the example may be denka black, carbon black, carbon nanotubes, carbon fiber, carbon nanowire, or a combination thereof.

The particle-shaped carbon may have a particle diameter of 5 nm to 700 nm, and for example, may have a particle diameter of 5 nm to 100 nm. Furthermore, the fiber-shaped carbon may have a length of 5 μm to 200 μm, and for example, may have a length of 10 μm to 50 μm, and may have a diameter of 20 nm or less, for example, 10 nm to 20 nm. When the particle diameter of the particle-shaped carbon is satisfied in the range, the resistance of the negative electrode may be reduced, and when the length and the diameter of the fiber-shaped carbon are satisfied in the range, the soft conductive network may be formed, and thus, the small amount may allow to effectively connect the active material particles. Accordingly, the electrical conductivity of the negative electrode may be improved.

Furthermore, when the fiber-shaped carbon with the length and the diameter is used together with the particle-shaped carbon, the used amount of the binder may be further decreased rather than when only using of the particle-shaped carbon, so that the swelling phenomenon due to the use together with the negative active material, particularly a silicon-based negative electrode active material, may be further suppressed.

The particle diameter may be an average particle diameter of particle diameters. Herein, the average particle diameter may mean a particle diameter (D50) by measuring a cumulative volume. In the specification, when a definition is not otherwise provided, such a particle diameter (D50) indicates an average particle diameter (D50) where a cumulative volume is about 50 volume % in a particle distribution. The length indicates a length of a long axis when the fiber-shaped carbon has a long axis and a short axis. The average particle size (D50) may be measured by a method well known to those skilled in the art, for example, by a particle size analyzer, or by a transmission electron microscopic image or a scanning electron microscopic image. Alternatively, a dynamic light-scattering measurement device is used to perform a data analysis, and the number of particles is counted for each particle size range. From this, the average particle diameter (D50) value may be easily obtained through a calculation.

In one embodiment, the negative electrode active material may be a carbon-based active material, a silicon-based active material, or a combination thereof.

As the carbon-based active material, crystalline carbon, amorphous carbon, or a combination thereof may be used. The example of the crystalline carbon may be graphite such as unspecified-shaped, plate-shaped, flake-shaped, spherical-shaped, or fiber-shaped natural graphite or artificial graphite, and the example of the amorphous carbon may be soft carbon or hard carbon, mesophase pitch carbide, sintered cokes, and the like.

The Si-based negative active material may be Si, a Si—C composite, SiOₓ (0<x<2), and a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof but not Si), and the Sn-based negative active material is selected from Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof but not Si), and the like, and also, a mixture of at least one thereof with SiO₂. The element Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The negative electrode active material layer may include a binder. When the negative electrode active material layer includes the negative electrode active material, lithium titanium oxide, and the conductive material, together with the binder, an amount of the negative electrode active material may be 92 wt % to 96 wt % based on the total weight of the negative electrode active material layer. In case of using the carbon-based active material and the silicon-based active material as the negative electrode active material, a mixing ratio may be 39:1 to 45:1 by weight ratio, and the use within the range may improve the adhesion between the current collector and the active material layer and increase the flexibility of the negative electrode. In addition, when the carbon-based active material is used together with the silicon-based active material, in the mixing ratio, the amount of Si may be suitably controlled to be 3 wt % to 7 wt % based on the total of 100 wt % of the negative electrode active material. When the amount of Si is within the range, the capacity may be increased.

An amount of the binder may be 1 wt % to 5 wt % based on the total weight of the negative electrode active material layer.

The binder improves binding properties of negative active material particles with one another and with a current collector. The binder may be a non-aqueous binder, an aqueous binder, or a combination thereof.

The non-aqueous binder may be ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamide imide, polyimide, or a combination thereof.

The aqueous binder may be a styrene-butadiene rubber (SBR), an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polypropylene, polyepichlorohydrin, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

When the aqueous binder is used as a negative electrode binder, a cellulose-based compound may be further used to provide viscosity as a thickener. The cellulose-based compound includes one or more of carboxymethyl cellulose, hydroxypropyl methylcellulose, methyl cellulose, or alkali metal salts thereof. The alkali metal may be Na, K, or Li. The thickener may be included in an amount of about 0.1 parts by weight to about 3 parts by weight based on 100 parts by weight of the negative electrode active material.

The current collector may include one selected from a copper foil, a nickel foil, a stainless steel foil, a titanium foil, a nickel foam, a copper foam, a polymer substrate coated with a conductive metal, and a combination thereof, but is not limited thereto.

The positive electrode may include a current collector and a positive electrode active material layer formed on the current collector.

The positive electrode active material may include lithiated intercalation compounds that reversibly intercalate and deintercalate lithium ions (lithiated intercalation compounds). Specifically, one or more composite oxides of a metal selected from cobalt, manganese, nickel, and a combination thereof, and lithium, may be used. More specifically, the compounds represented by one of the following chemical formulae may be used. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}O_{2-c}D_{c} (0.90≤a≤1.8, 0≤b≤0.5, 0≤c≤0.05); LiₐE_{2-b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0≤α≤2); LiₐNi_{1-b-c}Co_{b}X_{c}O_{2-α}T_{α} (0.90≤a≤1.8, 0≤b≤0.5, 0≤c≤0.5, 0≤α<2); LiₐNi_{1-b-c}Co_{b}X_{c}O_{2-α}T₂ (0.90≤a≤1.8, 0≤b≤0.5, 0≤c≤0.5, 0≤α<2); LiₐNi_{1-b-c}Mn_{b}X_{c}D_{α}(0.90≤a≤1.8, 0≤b≤0.5, 0≤c≤0.5, 0≤α≤2); LiₐNi_{1-b-c}Mn_{b}X_{c}O_{2-α}T_{α}(0.90≤a≤1.8, 0≤b≤0.5, 0≤c≤0.5, 0≤α≤2); LiₐNi_{1-b-c}Mn_{b}X_{c}O_{2-α}T₂ (0.90≤a≤1.8, 0≤b≤0.5, 0≤c≤0.5, 0≤α≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

Also, the compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method such as spray coating, dipping, and the like, but is not illustrated in more detail since it is well-known in the related field.

In the positive electrode, an amount of the positive electrode active material may be about 90 wt % to about 98 wt % based on the total weight of the positive electrode active material layer.

In one embodiment, the positive electrode active material layer may further include a binder and a conductive material. Herein, the binder and the conductive material may be included in an amount of about 1 wt % to about 5 wt %, respectively, based on the total amount of the positive electrode active material layer.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, and the like, but are not limited thereto.

The conductive material is included to provide electrode conductivity, and any electrically conductive material may be used as a conductive material unless it causes a chemical change. Examples of the conductive material include: a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may use aluminum foil, nickel foil, or a combination thereof, but is not limited thereto.

The negative electrode and the positive electrode active material layer may be prepared by mixing the active material, the binder and optionally, the conductive material in a solvent to prepare an active material composition and coating the active material composition on the current collector. Such an active material layer preparation is well-known in the related arts, and thus, the detailed description thereof will be omitted in the specification. The solvent may be N-methylpyrrolidone, and the like, and when the aqueous binder is used as the binder, water may be used as the solvent, but is not limited thereto.

The electrolyte includes a non-aqueous organic solvent and a lithium salt. The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethyl acetate, methyl propionate, ethyl propionate, decanolide, mevalonolactone, caprolactone, and the like. The ether-based solvent may include dibutyl ether, tetraglyme, diglyme, dimethoxyethane, 2-methyltetrahydrofuran, tetrahydrofuran, and the like. Furthermore, the ketone-based solvent includes cyclohexanone and the like. In addition, the alcohol-based solvent includes ethyl alcohol, isopropyl alcohol, and the like, and examples of the aprotic solvent include nitriles such as R—CN (where R is a C2 to C20 linear, branched, or cyclic hydrocarbon, or may include a double bond, an aromatic ring, or an ether bond), amides such as dimethylformamide, dioxolanes such as 1,3-dioxolane, sulfolanes, and the like.

The organic solvent may be used alone or in a mixture. When the organic solvent is used in a mixture, the mixture ratio may be controlled in accordance with a desirable battery performance, and it may be well understood to one that is ordinary skilled in the related art.

Furthermore, the carbonate-based solvent may include a mixture of a cyclic carbonate and a linear carbonate. Herein, the cyclic carbonate and the linear carbonate are mixed together in a volume ratio of about 1:1 to about 1:9, and when the mixture is used as an electrolyte, it may have enhanced performance.

When the non-aqueous organic solvents are mixed and used, a mixed solvent of a cyclic carbonate and a linear carbonate, a mixed solvent of a cyclic carbonate and a propionate-based solvent, or a mixed solvent of a cyclic carbonate, a linear carbonate and a propionate-based solvent may be used. The propionate-based solvent may include methyl propionate, ethyl propionate, propyl propionate, or a combination thereof.

Herein, when a mixture of a cyclic carbonate and a linear carbonate, or a mixture of a cyclic carbonate and a propionate-based solvent is used, it may be desirable to use it with a volume ratio of about 1:1 to about 1:9 considering the performances. Furthermore, a cyclic carbonate, a linear carbonate, and a propionate-based solvent may be mixed and used at a volume ratio of 1:1:1 to 3:3:4. Also, the mixing ratio of the solvents may be appropriately adjusted according to the desired properties.

The organic solvent may further include an aromatic hydrocarbon-based solvent as well as the carbonate-based solvent. Herein, the carbonate-based solvent and the aromatic hydrocarbon-based solvent may be mixed together in a volume ratio of about 1:1 to about 30:1. The aromatic hydrocarbon-based organic solvent may be an aromatic hydrocarbon-based compound represented by Chemical Formula 2.

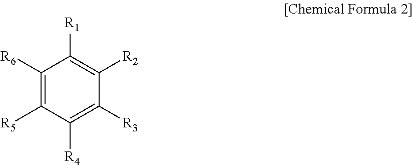

(In Chemical Formula 2, R₁ to R₆ are the same or different and are selected from hydrogen, a halogen, a C1 to C10 alkyl group, a haloalkyl group, and a combination thereof.)

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof. The electrolyte may further include vinylene carbonate, an ethylene carbonate-based compound represented by Chemical Formula 3, or propane sultone as an additive for improving cycle life.

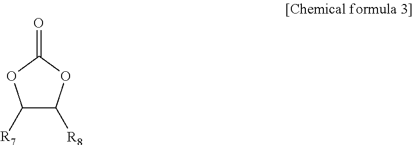

(In Chemical Formula 3, R₇ and R₈ are the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.)

Examples of the ethylene carbonate-based compound may include difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. In case of further using the additive for improving cycle life, an amount of the additive may be suitably controlled within an appropriate range. The non-aqueous organic solvent may further also include vinyl ethylene carbonate, hexane tricyanide, lithium tetrafluoroborate, propane sultone, and the like, as an additive.

The lithium salt dissolved in an organic solvent supplies a battery with lithium ions, basically operates the rechargeable lithium battery, and improves transportation of the lithium ions between positive and negative electrodes. Examples of the lithium salt may include one or two selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiN(CₓF₂ₓ₊₁SO₂)(C_{y}F_{2y+1}SO₂), where x and y are a natural numbers, for example, an integers of 1 to 20), LiCl, LiI, and LiB(C₂O₄)₂ (lithium bis(oxalato) borate: LiBOB), as a supporting salt. A concentration of the lithium salt may range from about 0.1 M to about 2.0 M. When the lithium salt is included at the above concentration range, an electrolyte may have excellent performance and lithium ion mobility due to optimal electrolyte conductivity and viscosity.

The lithium secondary battery may further include a separator between the negative electrode and the positive electrode, depending on a kind of the battery. Examples of a suitable separator material may include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

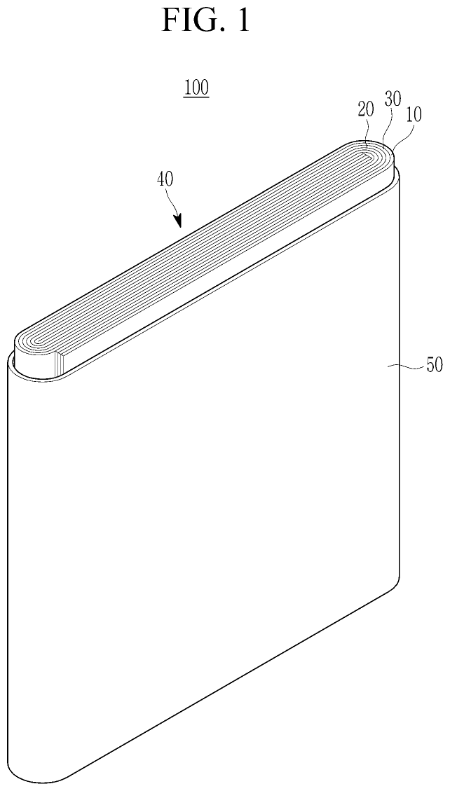

FIG. 1 is an exploded perspective view of a rechargeable lithium battery according to an embodiment. The lithium secondary battery according to an embodiment is illustrated as a prismatic battery, but is not limited thereto, and may include variously-shaped batteries such as a cylindrical battery, a pouch battery, and the like.

Referring to FIG. 1, a rechargeable lithium battery 100 according to an embodiment may include an electrode assembly 40 manufactured by winding a separator 30 disposed between a positive electrode 10 and a negative electrode 20, and a case 50 housing the electrode assembly 40. An electrolyte (not shown) may be impregnated in the positive electrode 10, the negative electrode 20, and the separator 30.

### DETAILED DESCRIPTION OF THE INVENTION

Hereinafter, examples of the present invention and comparative examples are described. These examples, however, are not in any sense to be interpreted as limiting the scope of the invention.

### Example 1

96 wt % of artificial graphite, 1 wt % of Li₄Ti₅O₁₂ with a size (diameter (particle diameter), particle-shaped) of 1 μm, 0.5 wt % of particle-shaped carbon (denka black) with an average particle diameter D50 of 30 nm, 1.5 wt % of styrene-butadiene rubber, and 1.0 wt % of carboxymethyl cellulose were mixed in a water solvent to prepare a negative electrode active material slurry. The prepared negative electrode active material slurry was coated on a Cu current collector and dried followed by pressing to prepare a negative electrode including a negative electrode active material layer on the current collector.

Using the prepared negative electrode, a lithium metal counter electrode, and an electrolyte, a half-cell was fabricated. As the electrolyte, 1.5M LiPF₆ dissolved in a mixed solvent of ethylene carbonate and ethyl methyl carbonate and dimethyl carbonate (20:40:40 volume ratio) was used.

### Example 2

A negative electrode was prepared by the same procedure as in Example 1, except that 0.5 wt % of carbon nanotubes (CNT) with a length of 10 μm and a diameter of 10 nm were used instead of 0.5 wt % of particle-shaped carbon (carbon black) with an average particle diameter D50 of 30 nm was used, and a half-cell was fabricated by using the negative electrode.

### Example 3

A negative electrode and a half-cell were fabricated by the same procedure as in Example 1, except that 96 wt % of artificial graphite, 1 wt % of Li₄Ti₅O₁₂ with a size of 1 μm, 0.25 wt % of particle-shaped carbon (denka black) with an average particle diameter D50 of 30 nm, 0.25 wt % of carbon nanotubes with a length of 50 μm and a diameter of 15 nm, 1.5 wt % of styrene-butadiene rubber, and 1.0 wt % of carboxymethyl cellulose were mixed to prepare a negative electrode active material, and the negative electrode active material slurry was used.

### Example 4

A negative electrode and a half-cell were fabricated by the same procedure as in Example 1, except that 91 wt % of artificial graphite, 5 wt % of Si, 1 wt % of Li₄Ti₅O₁₂ with a size of 1 μm, 0.5 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

### Example 5

A negative electrode and a half-cell were fabricated by the same procedure as in Example 1, except that 99.999 wt % of artificial graphite, 0.001 wt % of Li₄Ti₅O₁₂ with a size of 1 μm, 0.5 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

### Example 6

A negative electrode and a half-cell were fabricated by the same procedure as in Example 1, except that 95 wt % of artificial graphite, 2 wt % of Li₄Ti₅O₁₂ with a size of 1 μm, 0.5 wt % of particle-shaped carbon (denka black) with an average particle diameter D50 of 500 nm, 1.5 wt % of styrene-butadiene rubber, and 1.0 wt % of carboxymethyl cellulose were mixed to prepare a negative electrode active material, and the negative electrode active material slurry was used.

### Example 7

A negative electrode and a half-cell were fabricated by the same procedure as in Example 1, except that 96.999 wt % of artificial graphite, 0.001 wt % of Li₄Ti₅O₁₂ with a size of 1 μm, 0.5 wt % of particle-shaped carbon (denka black) with an average particle diameter D50 of 500 nm, 1.5 wt % of styrene-butadiene rubber, and 1.0 wt % of carboxymethyl cellulose were mixed to prepare a negative electrode active material, and the negative electrode active material slurry was used.

### Example 8

A negative electrode and a half-cell were fabricated by the same procedure as in Example 1, except that 94.4 wt % of artificial graphite, 2 wt % of Li₄Ti₅O₁₂ with a size of 1 μm, 1.1 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

### Example 9

A negative electrode and a half-cell were fabricated by the same procedure as in Example 1, except that 94.5 wt % of artificial graphite, 2 wt % of Li₄Ti₅O₁₂ with a size of 1 μm, 1 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

### Example 10

A negative electrode and a half-cell were fabricated by the same procedure as in Example 1, except that 95 wt % of artificial graphite, 2 wt % of Li₄Ti₅O₁₂ with a size of 1 μm, 0.5 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

### Example 11

A negative electrode and a half-cell were fabricated by the same procedure as in Example 1, except that 96.4 wt % of artificial graphite, 0.1 wt % of Li₄Ti₅O₁₂ with a size of 1 μm, 1 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

### Example 12

A negative electrode and a half-cell were fabricated by the same procedure as in Example 1, except that 97.3 wt % of artificial graphite, 0.1 wt % of Li₄Ti₅O₁₂ with a size of 1 μm, 0.1 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

### Comparative Example 1

A negative electrode and a half-cell were fabricated by the same procedure as in Example 1, except that 97.5 wt % of artificial graphite, 1.5 wt % of styrene-butadiene rubber, and 1.0 wt % of carboxymethyl cellulose were mixed to prepare a negative electrode active material, and the negative electrode active material slurry was used.

### Comparative Example 2

A negative electrode and a half-cell were fabricated by the same procedure as in Example 1, except that 96.5 wt % of artificial graphite, 1 wt % of Li₄Ti₅O₁₂ with a size of 1 μm, 1.5 wt % of styrene-butadiene rubber, and 1.0 wt % of carboxymethyl cellulose were mixed to prepare a negative electrode active material, and the negative electrode active material slurry was used.

### Comparative Example 3

A negative electrode and a half-cell were fabricated by the same procedure as in Example 1, except that 92 wt % of artificial graphite, 5 wt % of Si, 0.5 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

### Comparative Example 4

A negative electrode and a half-cell were fabricated by the same procedure as in Example 1, except that 94.5 wt % of artificial graphite, 2.5 wt % of Li₄Ti₅O₁₂ with a size of 1 μm, 0.5 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

### Comparative Example 5

A negative electrode and a half-cell were fabricated by the same procedure as in Example 1, except that 97 wt % of artificial graphite, 0.5 wt % of particle-shaped carbon (denka black) with an average particle diameter D50 of 500 nm, 1.5 wt % of styrene-butadiene rubber, and 1.0 wt % of carboxymethyl cellulose were mixed to prepare a negative electrode active material, and the negative electrode active material slurry was used.

### Comparative Example 6

A negative electrode and a half-cell were fabricated by the same procedure as in Example 1, except that 94.4 wt % of artificial graphite, 3.1 wt % of particle-shaped carbon (denka black) with an average particle diameter D50 of 30 nm, 1.5 wt % of styrene-butadiene rubber, and 1.0 wt % of carboxymethyl cellulose were mixed to prepare a negative electrode active material, and the negative electrode active material slurry was used.

(Evaluation 1) Measurement of Capacity

The half-cells according to Examples 1 to 12 and Comparative Examples 1 to 6 were stored at room temperature (25° C.) for 24 hours, and charged and discharged at 0.1 C, and the discharge capacity at 0.2 C after charging at 0.1 C, and the results are shown in Table 1.

(Evaluation 2) Measurement of Specific Resistance of Negative Electrode

The specific resistance for the negative electrodes according to Examples 1 to 12 and Comparative Examples 1 to 6 were measured and the results are shown in Table 1. The electrode specific resistance was measured by using an electrode electrical resistance meter (electrode conductivity meter, available from CIS Co. Ltd.) after sampling the negative electrode with 36 F (diameter 36 mm) at room temperature (25° C.).

(Evaluation 3) Measurement of Cycle-Life Characteristics

The half-cells according to Examples 1 to 12 and Comparative Examples 1 to 6 were charged and discharge at 1 C under 10° C. (low temperature) 100 times and the ratios of discharge capacity at the 100^{th} cycle to the discharge capacity at the 1^{st} cycle were calculated, and are shown in Table 1 as a low temperature cycle-life characteristic.

(Evaluation 4) Measurement of High-Rate Charge Characteristic

The half-cells according to Examples 1 and 2 and Comparative Examples 1 and 2 were charged at 2 C and discharged at 1 C at 25° C. (room temperature) 300 times and the ratio of 1 C discharge capacity at the 300^{th} cycle to the 1 C discharge capacity at the 1^{st} cycle were measured and are shown in Table 1 as a room temperature high-rate charge cycle-life-characteristic.

TABLE 1

| | | | | | | Room |
|---|---|---|---|---|---|---|
| | | | | Specific | Low | temperature |
| | | | | resistance | temperature | high-rate |
| | | | | of negative | cycle-life | cycle-life |
| | LTO | Conductive material | Capacity | electrode | characteristic | characteristic |
| | (wt %) | (wt %, type) | (mAh/g) | (Om) | (10° C., %) | (%) |
| Example 1 | 1 | 0.5 (particle-shaped | 340 | 0.37 | 79.2 | 89.4 |
| | | carbon) | | | | |
| Example 2 | 1 | 0.5 (CNT) | 340 | 0.35 | 76.2 | 89.1 |
| Example 3 | 1 | 0.25 (particle-shaped | 338 | 0.40 | 76.5 | 87.8 |
| | | carbon), | | | | |
| | | 0.25 (CNT) | | | | |
| Example 4 | 1 | 0.5 (particle-shaped | 385 | 0.43 | 75.8 | 88.9 |
| | | carbon) | | | | |
| Example 5 | 0.001 | 0.5 (particle-shaped | 346 | 0.16 | 75.6 | 87.0 |
| | | carbon) | | | | |
| Example 6 | 2 | 0.5 (particle-shaped | 339 | 0.26 | 78.1 | 88.7 |
| | | carbon) | | | | |
| Example 7 | 0.001 | 0.5 (particle-shaped | 346 | 0.22 | 75.4 | 86.8 |
| | | carbon) | | | | |
| Example 8 | 2 | 1.1 (particle-shaped | 336 | 0.16 | 77.4 | 87.5 |
| | | carbon) | | | | |
| Example 9 | 2 | 1 (particle-shaped | 337 | 0.16 | 77.7 | 88.2 |
| | | carbon) | | | | |
| Example 10 | 2 | 0.5 (particle-shaped | 339 | 0.19 | 79.1 | 88.5 |
| | | carbon) | | | | |
| Example 11 | 0.1 | 1 (particle-shaped | 344 | 0.13 | 75.5 | 87.2 |
| | | carbon) | | | | |
| Example 12 | 0.1 | 0.1 (particle-shaped | 347 | 0.2 | 75.4 | 87.1 |
| | | carbon) | | | | |
| Comparative | — | — | 345 | 0.45 | 72.4 | 81.4 |
| Example 1 | | | | | | |
| Comparative | 1 | — | 342 | 0.50 | 73.7 | 82.0 |
| Example 2 | | | | | | |
| Comparative | — | 0.5 (particle-shaped | 346 | 0.16 | 73.6 | 78.5 |
| Example 3 | | carbon) | | | | |
| Comparative | 2.5 | 0.5 (particle-shaped | 338 | 0.2 | 74.5 | 84.0 |
| Example 4 | | carbon) | | | | |
| Comparative | — | 0.5 (particle-shaped | 346 | 0.22 | 74.0 | 81.7 |
| Example 5 | | carbon) | | | | |
| Comparative | — | 3.1 (particle-shaped | 336 | 0.1 | 73.0 | 83.5 |
| Example 6 | | carbon) | | | | |

As shown in Table 1, the cells of Examples 1 to 12 using particle-shaped carbon or carbon nanotubes, or a combination thereof as the conductive material, and using lithium titanium oxide, exhibited low specific resistance of the negative electrode, excellent low temperature cycle-life, and a room temperature high-rate charge characteristic. Whereas, Comparative Examples 1 to 6 in which at least one of lithium titanium oxide, or particle-shaped carbon or carbon nanotubes were not used, or lithium titanium oxide was used at a large amount, even though both were used, exhibited a deteriorated low temperature cycle-life-characteristic and a room temperature high-rate charge characteristic.

From the results of Table 1, when lithium titanium oxide and the conductive material of particle-shaped carbon, carbon nanotubes, or a combination thereof are used, particularly, when lithium titanium oxide is used at an amount of 2 wt % or less based on the 100 wt % of the negative electrode active material layer, the specific resistance of the negative electrode may be reduced and the cycle-life characteristic may be improved.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

1. A negative electrode for a lithium secondary battery comprising:
a current collector; and
a negative electrode active material layer formed on the current collector and comprising a negative electrode active material, lithium titanium oxide and a conductive material,
wherein an amount of the lithium titanium oxide is 2 wt % or less relative to 100 wt % of the negative electrode active material layer.

2. The negative electrode for a lithium secondary battery of claim 1, wherein:
the conductive material is a particle-shaped carbon, a fiber-shaped carbon, or a combination thereof.

3. The negative electrode for a lithium secondary battery of claim 2, wherein the conductive material is denka black, carbon black, carbon nanotubes, carbon fiber, carbon nanowire, or a combination thereof.

4. The negative electrode for a lithium secondary battery of claim 1, wherein the particle-shaped carbon has a particle diameter of 5 nm to 700 nm.

5. The negative electrode for a lithium secondary battery of claim 1, wherein the fiber-shaped carbon has a length of 5 μm to 200 μm and a diameter of 20 nm or less.

6. The negative electrode for a lithium secondary battery of claim 1, wherein the amount of lithium titanium oxide is 0.001 wt % to 2 wt % relative to 100 wt % of the negative electrode active material layer.

7. The negative electrode for a lithium secondary battery of claim 1, wherein a total amount of lithium titanium oxide and the conductive material is 3.5 wt % or less relative to 100 wt % of the negative electrode active material layer.

8. The negative electrode for a lithium secondary battery of claim 1, wherein a mixing ratio of the lithium titanium oxide and the conductive material is 0.002:1 to 4:1 by weight ratio.

9. The negative electrode for a lithium secondary battery of claim 1, wherein lithium titanium oxide is represented by Chemical Formula 1.
Li₄₊ₓTi_{y}M_{z}Oₜ [Chemical Formula 1]
(in Chemical Formula 1, 0<x≤3, 1≤y≤5, 0≤z≤3, 3≤t≤12, and M is an element selected from Mg, La, Tb, Gd, Ce, Pr, Nd, Sm, Ba, Sr, Ca, or a combination thereof).

10. The negative electrode for a lithium secondary battery of claim 1, wherein:
the negative electrode active material is a carbon-based active material, a silicon-based active material, or a combination thereof.

11. A lithium secondary battery, comprising
a negative electrode of claim 1;
a positive electrode; and
an electrolyte.
